(19) United States
(12) Patent Application Publication
(10) Pub. No.: US 2017/0081249 A1
(43) Pub. Date: Mar. 23, 2017

(54) Concrete Wet Cast Ready Mix Composition

(71) Applicants: Anthony Gauci, Wallarah (AU); Michael R. Meyer, Alpena, MI (US)

(72) Inventors: Anthony Gauci, Wallarah (AU); Michael R. Meyer, Alpena, MI (US)

(21) Appl. No.: 14/862,493

(22) Filed: Sep. 23, 2015

(51) Int. Cl. C04B 40/00

(52) U.S. Cl. CPC C04B 40/0039

(57) ABSTRACT

A concrete block wet cast ready mix composition preferably includes ground recycled glass, river sand, river gravel, cement, soap, water and a water proofing substance. The river gravel preferably includes natural stone, granite, limestone and domite. The cement is preferably an off-white cement. The soap is preferably laundry detergent. The water proofing substance is preferably Grace Optec Admix waterproofing. The wet cast composition is preferably mixed in the following manner. The ground recycled glass, the river sand and the river gravel are mixed together to form an aggregate mix. The cement is combined with the aggregate mix to form a cement aggregate mix. Water is added to the cement aggregate mix to form a wet aggregate mix. Finally, the soap and the waterproofing substance are combined with the wet aggregate mix. The wet cast composition is now ready to be poured into concrete block molds or poured as cast concrete.

### BACKGROUND OF THE INVENTION

1. Field of the Invention

The present invention relates generally to masonry and more specifically to a concrete wet cast ready mix composition, which is hydrophobic.

2. Discussion of the Prior Art

It appears that the prior art does not disclose a concrete wet cast ready mix composition, which is hydrophobic and also provides vibrant color when a colorant is mixed therein.

Accordingly, there is a clearly felt need in the art for a concrete wet cast ready mix composition, which is hydrophobic and has the unexpected result of providing a more vibrant color than that of the prior art when a colorant is added to the mixture.

### SUMMARY OF THE INVENTION

The present invention provides a concrete wet cast ready mix composition, which is hydrophobic. The concrete wet cast ready mix composition (wet cast composition) preferably includes ground recycled glass, river sand, river gravel, cement, soap, water and a water proofing substance. The river gravel preferably includes natural stone, granite, limestone and domite. The cement is preferably off-white cement. The soap is preferably laundry detergent. The water proofing substance is preferably Grace Optec Admix waterproofing. The wet cast composition is preferably mixed in the following manner. The ground recycled glass, the river sand and the river gravel are mixed together to form an aggregate mix. The cement is combined with the aggregate mix to form a cement aggregate mix. Water is added to the cement aggregate mix to form a wet aggregate mix. Finally, the soap and the waterproofing substance are combined with the wet aggregate mix. A liquid colorant may be added with the soap and waterproofing. The wet cast composition is now ready to be poured into concrete block molds or poured as cast concrete.

Accordingly, it is an object of the present invention to provide a concrete wet cast composition, which is hydrophobic.

Finally, it is another object of the present invention to provide a concrete wet cast composition, which has the unexpected result of providing a more vibrant color than that of the prior art when a colorant is added to the mixture.

These and additional objects, advantages, features and benefits of the present invention will become apparent from the following specification.

### DETAILED DESCRIPTION OF THE PREFERRED EMBODIMENTS

The wet cast composition preferably includes ground recycled glass, river sand, river gravel, cement, soap, water and a water proofing substance. The river gravel preferably includes natural stone, granite, limestone and domite. However, other types of stone may also be used. The cement is preferably an off-white cement. The soap is preferably laundry detergent. The soap acts as a lubricant and adds needed air to the wet cast composition. The addition of soap is optional. The waterproofing substance is preferably Grace Optec Admix waterproofing. Applicant defines the following abbreviations as follows: kilograms (kg), milliliters (ml), millimeters (mm) and micrometers (um). A preferred range of weights of the components in the wet cast composition is ground recycled glass 100 kg-600 kg, cement 50 kg-300 kg, river gravel 50 kg-300 kg, river sand 75 kg-400 kg, water 15 liters-100 liters, water proofing 150 ml-1600 ml and soap 15 ml -200 ml. The square screen size for river gravel is 5 mm-10 mm for concrete block and 5 mm-38 mm for cast concrete. The square screen size for ground recycled glass is no greater than 5 mm. The square screen size for river sand is 150 um-10 mm. The following weights of components are given by way of example and not by way of limitation. The following weights of components have been found to provide a satisfactory wet cast composition, cement 150 kg, river gravel 150 kg, river sand 200 kg, ground glass 300 kg, water 50 liters, water proofing 0.5 liter and soap 50 milliliters.

The wet cast composition is preferably mixed in the following manner. The ground recycled glass, the river sand and the river gravel are mixed together to form an aggregate mix. The cement is combined with the aggregate mix to form a cement aggregate mix. A granular based colorant may be added to the cement aggregate mix at this step. Water is added to the cement aggregate mix to form a wet aggregate mix. If the colorant is liquid, the colorant is added with the water. Finally, the soap and the water proofing substance are combined with the wet aggregate mix. The wet cast composition is now ready to be poured into concrete block molds or poured as cast concrete.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of preparing a wet cast ready mix composition for producing concrete blocks or wet cast concrete comprising the steps of:
providing ground recycled glass;
providing river sand;
mixing river gravel with said ground recycled glass and said river sand to form an aggregate mix;
mixing a cement with said aggregate mix to form a cement aggregate mix;
mixing water in said aggregate mix to form a wet aggregate mix; and
mixing water proofing in said wet aggregate mix.

2. The method of preparing a wet cast ready mix composition for producing concrete blocks or wet cast concrete of claim 1, further comprising the step of:
adding a granular based colorant to said cement aggregate mix.

3. The method of preparing a wet cast ready mix composition for producing concrete blocks or wet cast concrete of claim 1, further comprising the step of:
adding a liquid colorant to said wet aggregate mix.

4. The method of preparing a wet cast ready mix composition for producing concrete blocks or wet cast concrete of claim 1, further comprising the step of:
providing at least one of natural stone, granite, limestone and domite for said river gravel.

5. The method of preparing a wet cast ready mix composition for producing concrete blocks or wet cast concrete of claim 1, further comprising the step of:
providing off-white cement for said cement.

6. The method of preparing a wet cast ready mix composition for producing concrete blocks or wet cast concrete of claim 1, further comprising the step of:
pouring said wet cast ready mix composition into at least one of a concrete block mold or as cast concrete.

7. A method of preparing a wet cast ready mix composition for producing concrete blocks or wet cast concrete comprising the steps of:
providing ground recycled glass having a weight range of 100 kg-600 kg;
providing river sand having a weight range of 75 kg to 400 kg;
mixing river gravel having a weight range of 50 kg to 300 kg with said ground recycled glass and said river sand to form an aggregate mix;
mixing cement having a weight range of 50 kg to 300 kg with said aggregate mix to form a cement aggregate mix;
mixing water having a weight range of 15 liters to 100 in said aggregate mix to form a wet aggregate mix; and
mixing waterproofing having a weight range of 150 ml to 1600 ml in said wet aggregate mix.

8. The method of preparing a wet cast ready mix composition for producing concrete blocks or wet cast concrete of claim 7, further comprising the step of:
adding a granular based colorant to said cement aggregate mix.

9. The method of preparing a wet cast ready mix composition for producing concrete blocks or wet cast concrete of claim 7, further comprising the step of:
adding a liquid colorant to said wet aggregate mix.

10. The method of preparing a wet cast ready mix composition for producing concrete blocks or wet cast concrete of claim 7, further comprising the step of:
providing at least one of natural stone, granite, limestone and domite for said river gravel.

11. The method of preparing a wet cast ready mix composition for producing concrete blocks or wet cast concrete of claim 7, further comprising the step of:
providing off-white cement for said cement.

12. The method of preparing a wet cast ready mix composition for producing concrete blocks or wet cast concrete of claim 7, further comprising the step of:
pouring said wet cast ready mix composition into at least one of a concrete block mold or as cast concrete.

13. The method of preparing a wet cast ready mix composition for producing concrete blocks or wet cast concrete of claim 7, further comprising the step of:
adding soap to said water proofing.

14. The method of preparing a wet cast ready mix composition for producing concrete blocks or wet cast concrete of claim 13, further comprising the step of:
providing laundry detergent for said soap.

15. A method of preparing a wet cast ready mix composition for producing concrete blocks or wet cast concrete comprising the steps of:
providing a ground recycled glass;
providing a river sand;
mixing river gravel with said ground recycled glass and said river sand to form an aggregate mix;
mixing cement with said aggregate mix to form a cement aggregate mix;
mixing water in said aggregate mix to form a wet aggregate mix;
mixing waterproofing in said wet aggregate mix; and
mixing soap in said wet aggregate mix.

16. The method of preparing a wet cast ready mix composition for producing concrete blocks or wet cast concrete of claim 15, further comprising the step of:
adding a granular based colorant to said cement aggregate mix.

17. The method of preparing a wet cast ready mix composition for producing concrete blocks or wet cast concrete of claim 15, further comprising the step of:
adding a liquid colorant to said wet aggregate mix.

18. The method of preparing a wet cast ready mix composition for producing concrete blocks or wet cast concrete of claim 15, further comprising the step of:
providing at least one of natural stone, granite, limestone and domite for said river gravel.

19. The method of preparing a wet cast ready mix composition for producing concrete blocks or wet cast concrete of claim 15, further comprising the step of:
providing off-white cement for said cement.

20. The method of preparing a wet cast ready mix composition for producing concrete blocks or wet cast concrete of claim 15, further comprising the step of:
pouring said wet cast ready mix composition into at least one of a concrete block mold or as cast concrete.
